(19) United States
(12) Patent Application Publication
(10) Pub. No.: US 2011/0012042 A1
(43) Pub. Date: Jan. 20, 2011

(54) Water flushing device for floor toilet

(76) Inventor: Meng Meng Chen, Changhua Hsien (TW)

Correspondence Address: CHARLES E. BAXLEY, ESQUIRE, 90 JOHN STREET, SUITE 403, NEW YORK, NY, 10038, US

(21) Appl. No.: 12/460,188

(22) Filed: Jul. 15, 2009

(51) Int. Cl. F16K 31/44

(52) U.S. Cl. 251/231

(57) ABSTRACT

A water flushing device includes a membrane engaged onto a housing, a casing extended in the housing for forming an outer peripheral space between the housing and the casing, a valve device for selectively blocking and opening an opening of the membrane, a barrel mounted to the membrane and engaged in the casing, the membrane includes a stepped orifice having a narrowed and a relatively wider orifice portions for forming an inner peripheral shoulder, a gasket includes an outer peripheral flange engaged into the relatively wider orifice portion of the membrane and includes one or more slots formed in the outer peripheral flange for allowing the water to quickly flow into a sealed upper compartment of the housing.

### BACKGROUND OF THE INVENTION

1. Field of the Invention

The present invention relates to a water flushing device for a floor toilet, and more particularly to a water flushing device for a floor toilet including a structure for allowing the water flushing quantity or the water flushing speed to be suitably increased or facilitated.

2. Description of the Prior Art

Typical water flushing devices for the floor toilets comprise a housing disposed on the floor and coupled to a water reservoir for receiving the water from the water reservoir, the housing including an outlet port directed or coupled to the floor toilet bowl, a membrane disposed in the housing, a valve device disposed in the housing for controlling the water to flow through the membrane and to flow from the housing to the floor toilet bowl, and an actuating handle or lever coupled to the valve device for actuating or operating the valve device to control the water to flow from the housing to the floor toilet bowl.

The valve device may be actuated or operated by the actuating handle or lever in order to open the water flowing passage in the housing when required, and may be actuated or operated by the water flowing into the housing. One or more gaskets are engaged into or through the membrane and each include a bore for controlling the water flowing through the membrane.

However, the bore of the gaskets includes a small inner diameter that the water may not quickly flow through the bores of the gaskets and also may not quickly flow through the water flowing passage of the membrane.

The present invention has arisen to mitigate and/or obviate the afore-described disadvantages of the conventional water flushing devices for the floor toilets.

### SUMMARY OF THE INVENTION

The primary objective of the present invention is to provide a water flushing device including a structure for allowing the water flushing quantity or the water flushing speed to be suitably increased or facilitated.

In accordance with one aspect of the invention, there is provided a water flushing device comprising a housing including an inlet port for receiving water, and including an outlet port, and including a casing extended in the housing for forming an outer peripheral space between the housing and the casing, and for forming a bore within the casing, and the outer peripheral space formed and located between the housing and the casing being communicative with the inlet port for receiving the water from the inlet port, a membrane including an outer peripheral portion engaged onto an upper portion of the housing for blocking the upper portion of the housing and for forming a compartment above the membrane and in the housing, and including an opening formed therein, and including a stepped orifice formed therein and having a narrowed orifice portion and a relatively wider orifice portion communicative with each other for forming an inner peripheral shoulder between the narrowed and the relatively wider orifice portions, a valve device for selectively opening and blocking the opening of the membrane, a barrel mounted to the membrane and engaged in the chamber of the casing, and including a bore formed therein and communicative with the chamber of the casing for allowing the water from the compartment of the housing to selectively flow out through the bore of the barrel and to flow out into the chamber of the casing, and a gasket engaged into the stepped orifice of the membrane, and including a bore formed therein, and including an outer peripheral flange engaged into the relatively wider orifice portion of the membrane and engaged with the inner peripheral shoulder of the membrane for anchoring the gasket to the membrane, and including at least one slot formed in the outer peripheral flange and extended radially for allowing the water to flow through the slot of the outer peripheral flange of the gasket and to flow into the compartment of the housing.

The outer peripheral flange of the gasket includes a thickness smaller than a depth of the wider orifice portion of the membrane for allowing the outer peripheral flange of the gasket to be engaged within the wider orifice portion of the membrane.

The membrane includes a protruded flange extended outwardly from the membrane and disposed and arranged around the narrowed orifice portion of the membrane.

The gasket includes a lower peripheral flange engaged with the protruded flange of the membrane. The bore of the gasket is a stepped bore.

The membrane includes an inner peripheral rim and an outer peripheral rim for forming and defining a middle peripheral portion between the inner peripheral rim and the outer peripheral rim.

The membrane includes a plurality of bulges formed and located in the middle peripheral portion for reinforcing the membrane. The membrane includes a blade engaged in the inner peripheral rim for reinforcing the membrane.

A cover is further provided and engaged onto the housing and engaged with the outer peripheral rim of the membrane for forming a sealed compartment between the membrane and the cover.

A cap is further provided and engaged with the barrel and engaged with the inner peripheral rim of the membrane for securing the barrel to the membrane.

The membrane includes at least one depression formed in an outer peripheral portion of the inner peripheral rim.

The membrane includes a plurality of cavities formed and located in the middle peripheral portion of the membrane. The membrane includes a plurality of bars extended outwardly from the membrane and disposed and arranged around the cavities of the membrane for reinforcing the membrane.

The barrel includes a bore communicative with the opening of the membrane, and the valve device includes a stem extended into the bore of the barrel. An actuating device is further provided and attached and secured to the housing and includes an actuating rod extended into the housing and engageable with the stem of the valve device for selectively tilting the stem and the valve device relative to the barrel, and includes an actuating lever extended out of the housing for operating the actuating rod.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a water flushing device in accordance with the present invention;

FIG. 2 is a partial cross sectional view of the water flushing device;

FIG. 3 is an enlarged partial cross sectional view of the water flushing device;

FIG. 4 is an upper perspective view illustrating a membrane of the water flushing device;

FIG. 5 is another partial exploded view of the membrane of the water flushing device;

FIG. 6 is a bottom perspective view of the membrane of the water flushing device;

FIG. 7 is an upper perspective view illustrating a gasket of the water flushing device;

FIG. 8 is another upper perspective view illustrating the other arrangement of the gasket of the water flushing device;

FIG. 9 is an enlarged partial cross sectional view of the water flushing device; and

FIG. 10 is a further enlarged partial cross sectional view of the water flushing device.

### DETAILED DESCRIPTION OF THE PREFERRED EMBODIMENT

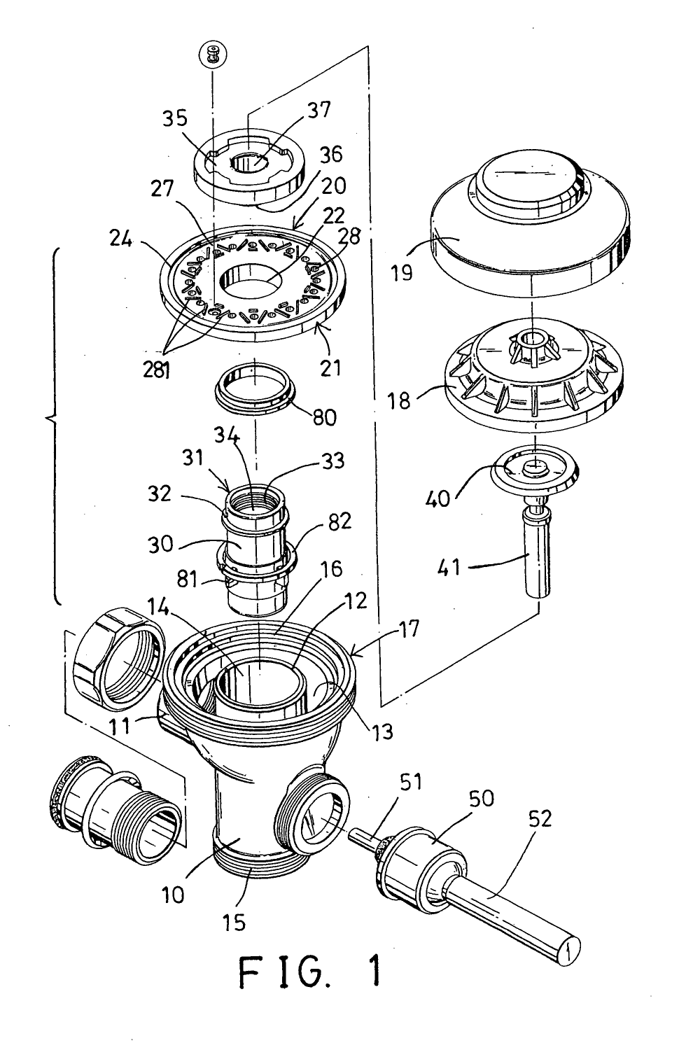

Referring to the drawings, and initially to FIGS. 1-3, a water flushing device in accordance with the present invention comprises a housing 10 for being disposed on the floor (not shown), and including an inlet port 11 for coupling to a water reservoir (not shown) and for receiving the water from the water reservoir, the housing 10 includes a cylindrical casing 12 extended in the housing 10 for forming an outer peripheral space 13 between the housing 10 and the casing 12, and for forming a chamber 14 within the casing 12, and the outer peripheral space 13 formed and located between the housing 10 and the casing 12 is communicative with the inlet port 11 for receiving the water from the inlet port 11, the housing 10 includes an outlet port 15 directed or coupled to the floor toilet bowl (not shown) for selectively supplying the water to the floor toilet bowl.

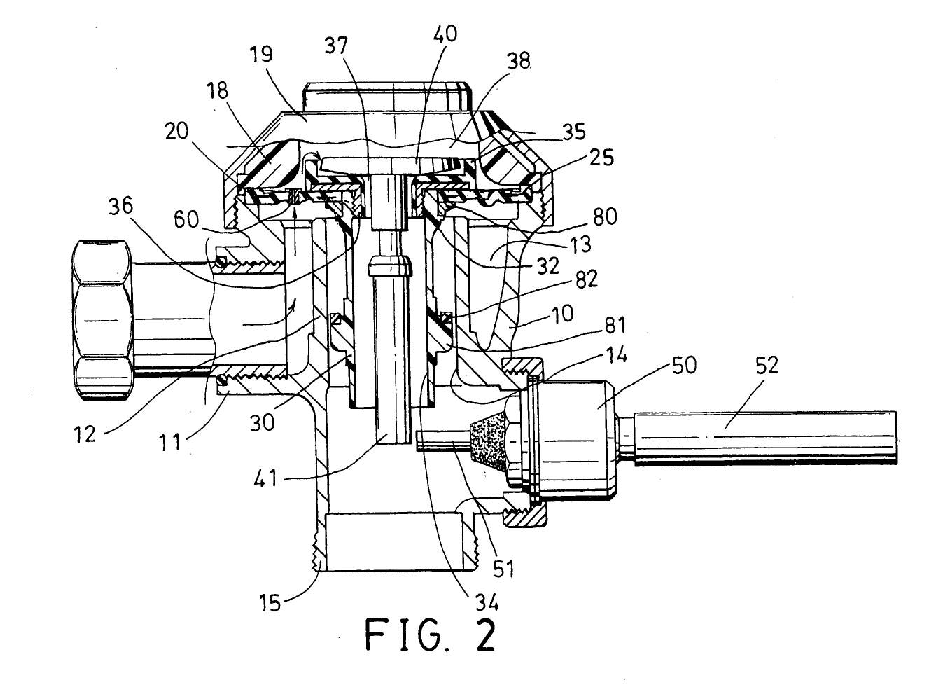

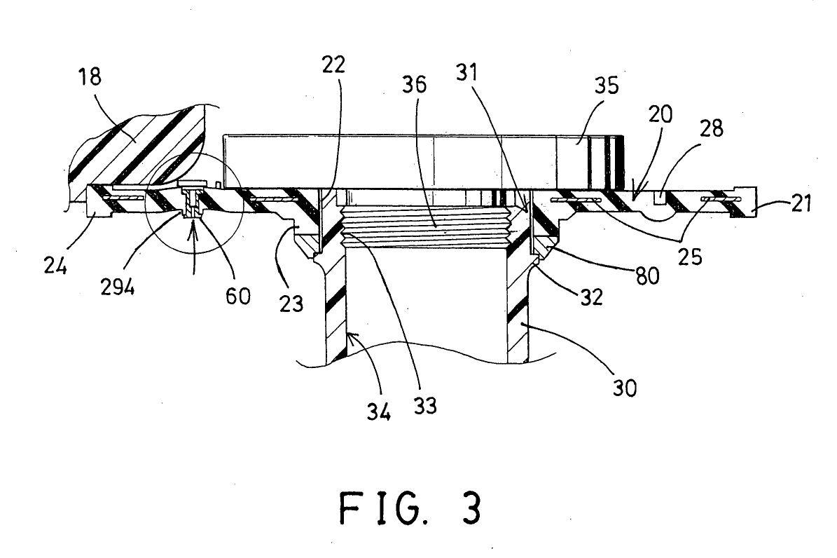

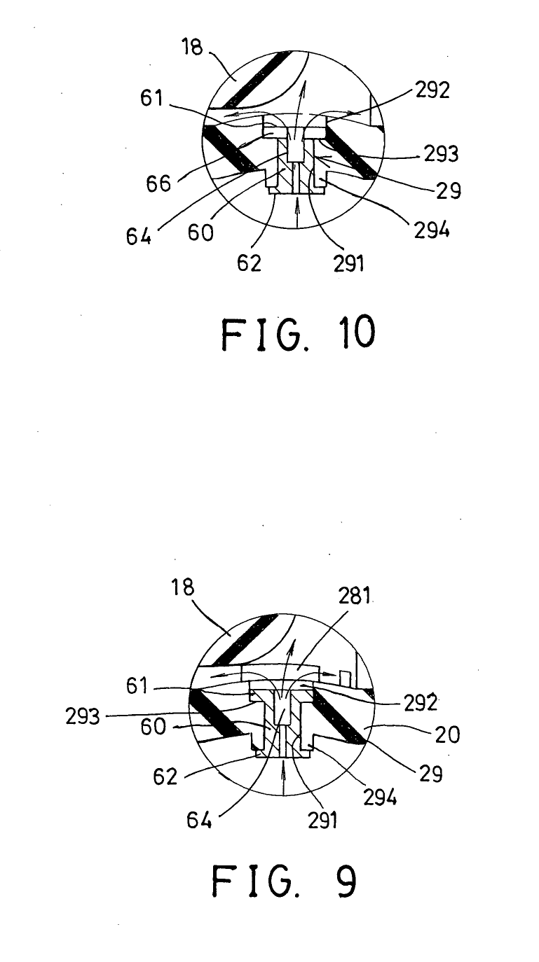

The housing 10 further includes an inner peripheral shoulder 16 formed in the upper portion 17 thereof and located above or higher than the upper portion of the casing 12 (FIG. 2). As shown in FIGS. 1-6 and 9-10, a soft or resilient film or membrane 20 includes an outer peripheral portion 21 engaged onto or into the peripheral shoulder 16 or the upper portion 17 of the housing 10 for blocking or sealing the upper portion of the housing 10 and/or the casing 12, and includes a center opening 22 formed therein. It is preferable that the membrane 20 includes an inner peripheral rim 23 and an outer peripheral rim 24 each having a resilient blade 25, such as a circular blade 25 engaged therein (FIGS. 3, 5) for reinforcing the membrane 20, and includes a number of swellings or bulges 26 formed on the bottom portion thereof (FIG. 6) and located in the middle peripheral portion 27 that is formed or defined between the rims 23, 24 for further reinforcing the membrane 20.

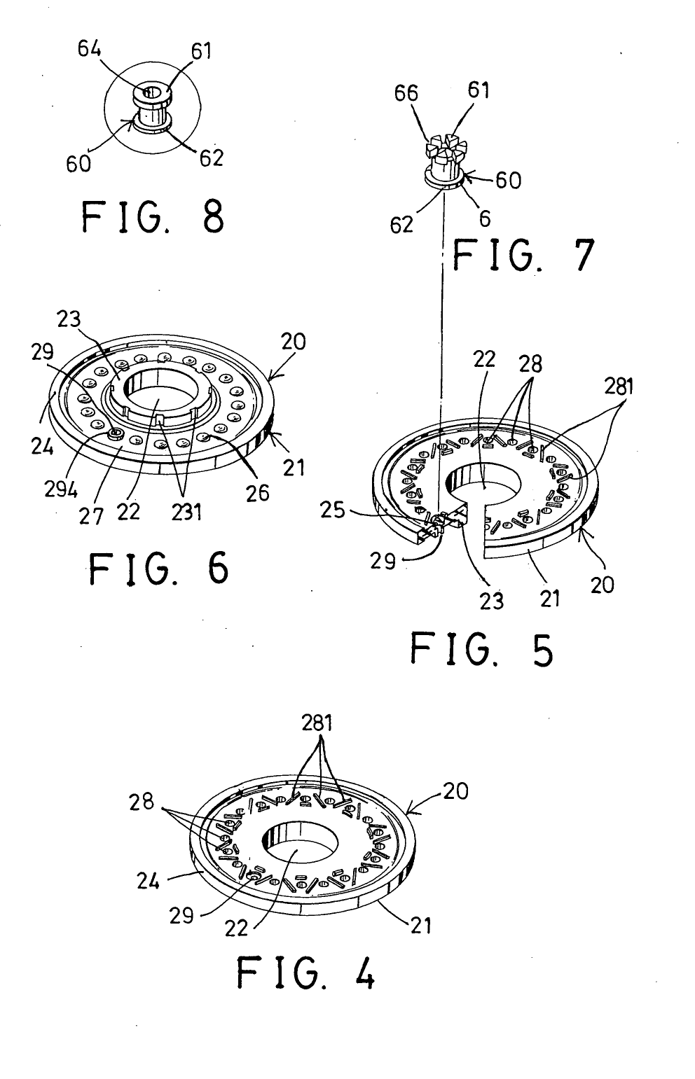

The membrane 20 further includes a number of cavities 28 formed on the upper portion thereof (FIGS. 3-5) and aligned with the bulges 26, and includes one or more stepped orifices 29 formed in the middle peripheral portion 27 of the membrane 20 (FIG. 2). It is preferable that the membrane 20 further includes a number of depressions 231 formed on the outer peripheral portion of the inner peripheral rim 23 of the membrane 20 (FIG. 3) for noise reducing purposes, and further includes a number of metal ribs or bars 281 (FIGS. 4, 5) extended outwardly from the membrane 20 and disposed and arranged around the cavities 28 of the membrane 20 for further reinforcing the membrane 20. Each stepped orifice 29 of the membrane 20 includes a narrowed orifice portion 291 and an enlarged or relatively wider orifice portion 292 communicative with each other for forming an inner peripheral shoulder 293 between the orifice portions 291, 292, and the membrane 20 includes a peripheral or annular protruded flange 294 extended outwardly from the membrane 20 and disposed and arranged around the narrowed orifice portion 291 of the membrane 20.

One or more barrels 30 each include an upper portion 31 selectively or changeably engaged into the opening 22 of the membrane 20 (FIGS. 1-3) and engaged in the chamber 14 of the casing 12 (FIG. 2), and includes an outer peripheral flange 32 extended outwardly from the upper portion 31 thereof for engaging with the membrane 20 directly, or indirectly with a gasket 80 and for anchoring or positioning or attaching or mounting the barrel 30 to the membrane 20, and includes an inner thread 33 formed in the upper portion 31 thereof, and includes a bore 34 formed therein. A lock nut or cap 35 includes a shank 36 extended downwardly therefrom and threaded or engaged with the inner thread 33 of the barrel 30 and engaged with the inner peripheral rim 23 of the membrane 20 for solidly securing the barrel 30 to the membrane 20, and includes an aperture 37 formed therein and communicative with the bore 34 of the barrel 30, and arranged for allowing the water to flow from the outer peripheral space 13 of the housing 10 through the orifice 29 of the membrane 20, and then to flow into the aperture 37 of the cap 35 and the bore 34 of the barrel 30, and then to flow out through the outlet port 15 of the housing 10 (FIG. 2). One or more sealing rings 82 may further be attached to the barrel 30 and engaged with the projections 81 of the barrel 30 for partially blocking the space formed between the barrel 30 and the casing 12.

An inner cover 18 is engaged onto the upper portion 17 of the housing 10 and engaged with the outer peripheral rim 24 of the membrane 20 for forming or defining a sealed compartment 38 (FIG. 2) above the membrane 20 or between the membrane 20 and the inner cover 18, and an outer cover 19 is engaged onto the upper or outer portion of the inner cover 18 and threaded or engaged with the upper portion 17 of the housing 10 for solidly securing the inner cover 18 and the membrane 20 to the upper portion 17 of the housing 10. The compartment 38 of the inner cover 18 is communicative with the aperture 37 of the cap 35 and the bore 34 of the barrel 30 and is also communicative with the outer peripheral space 13 of the housing 10 through the orifice 29 of the membrane 20 for allowing the water to flow from the outer peripheral space 13 of the housing 10 through the orifice 29 of the membrane 20, and then to flow into the aperture 37 of the cap 35 and the bore 34 of the barrel 30.

A valve device 40 is disposed above or higher than the upper portion of the cap 35 and engageable with the cap 35 for selectively blocking or sealing the aperture 37 of the cap 35 and/or the opening 22 of the membrane 20, and for controlling the water to flow from the compartment 38 of the inner cover 18 into or through the aperture 37 of the cap 35 and the bore 34 of the barrel 30. The valve device 40 includes a stem 41 extended downwardly therefrom and extended into or through the aperture 37 of the cap 35 and the bore 34 of the barrel 30, and the aperture 37 of the cap 35 may be selectively opened when the stem 41 of the valve device 40 is tilted relative to the cap 35 and the barrel 30, and may be selectively blocked by the valve device 40 when the stem 41 of the valve device 40 is not tilted relative to the cap 35 and the barrel 30.

An actuating device 50 is attached or secured to the housing 10, and includes an actuating rod 51 extended into the housing 10 and engageable with the stem 41 of the valve device 40 for selectively tilting the stem 41 and the valve device 40 relative to the cap 35 and the barrel 30, and thus for selectively opening the aperture 37 of the cap 35 and thus for allowing the water to be controlled to flow from the compartment 38 of the inner cover 18 into or through the aperture 37 of the cap 35 and the bore 34 of the barrel 30. The actuating device 50 includes an actuating handle or lever 52 coupled thereto and extended out of the housing 10 for actuating or operating the actuating rod 51 to selectively tilt the stem 41 and the valve device 40 relative to the cap 35 and the barrel 30, in which the above-described structure of the actuating rod 51 and the actuating handle or lever 52 of the actuating device 50 is not related to the present invention and will not be described in further details.

As shown in FIGS. 2-3, 5 and 7, the membrane 20 further includes one or more plugs or gaskets 60 for engaging into or through the stepped orifice 29 of the membrane 20, and the gaskets 60 each include two outer peripheral flanges 61, 62 extended outwardly from the upper portion and the lower portion thereof respectively for engaging with the membrane 20 and for anchoring or positioning the gaskets 60 to the membrane 20, and the outer peripheral flange 62 of the gaskets 60 is engaged with the protruded flange 294 of the membrane 20 (FIGS. 3, 9-10) for stably anchoring the gaskets 60 to the membrane 20, the gaskets 60 may also be easily and quickly disengaged from the membrane 20, and the gaskets 60 include a stepped bore 64 formed therein for allowing the water to flow through the stepped bores 64 of the gaskets 60 and to flow through the membrane 20 (FIGS. 3 and 9-10).

The upper peripheral flanges 61 of the gaskets 60 are engaged into the wider orifice portion 292 of the membrane 20 and engaged with the inner peripheral shoulder 293 of the membrane 20 and include a thickness smaller than the thickness or the depth of the wider orifice portion 292 of the membrane 20 for allowing the upper peripheral flanges 61 of the gaskets 60 to be engaged within the wider orifice portion 292 of the membrane 20. The gaskets 60 each further include one or more slots 66 formed in the other or upper peripheral flange 61 and extended radially and arranged for allowing the water that flows through the bores 64 of the gaskets 60 to quickly flow through the slots 66 of the upper peripheral flange 61 of the gasket 60 (FIGS. 7, 10) and to quickly flow into the compartment 38 of the inner cover 18 (FIG. 2), such that the water flushing speed through the membrane 20 may be suitably increased or facilitated. The formation or the provision of the depressions 231 in the outer peripheral portion of the inner peripheral rim 23 of the membrane 20 may suitably engage with the water in order to suitably reduce the noise that may be generated by the flowing of the water.

In operation, as shown in FIG. 2, the stem 41 of the valve device 40 may be selectively tilted relative to the cap 35 and the barrel 30 with the actuating rod 51 and the actuating handle or lever 52 of the actuating device 50 in order to selectively open the aperture 37 of the cap 35 and to allow the water to flow out through the outlet port 15 of the housing 10. The slots 66 of the gaskets 60 may facilitate the flowing of the water through the bores 64 of the gaskets 60 and through the orifice 29 of the membrane 20, and the engagement of the upper peripheral flanges 61 of the gaskets 60 within the wider orifice portion 292 of the membrane 20 may further facilitate the flowing of the water through the bores 64 of the gaskets 60 and through the orifice 29 of the membrane 20. The depressions 231 formed or provided in the outer peripheral portion of the inner peripheral rim 23 of the membrane 20 may suitably decrease or reduce the noise that may be generated by the flowing of the water.

Accordingly, the water flushing device includes a structure for allowing the water flushing quantity or the water flushing speed to be suitably increased or facilitated.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A water flushing device comprising:
a housing including an inlet port for receiving water, and including an outlet port, and including a casing extended in said housing for forming an outer peripheral space between said housing and said casing, and for forming a bore within said casing, and said outer peripheral space formed and located between said housing and said casing being communicative with said inlet port for receiving the water from said inlet port,
a membrane including an outer peripheral portion engaged onto an upper portion of said housing for blocking said upper portion of said housing and for forming a compartment above said membrane and in said housing, and including an opening formed therein, and including a stepped orifice formed therein and having a narrowed orifice portion and a relatively wider orifice portion communicative with each other for forming an inner peripheral shoulder between said narrowed and said relatively wider orifice portions,
a valve device for selectively opening and blocking said opening of said membrane,
a barrel mounted to said membrane and engaged in said chamber of said casing, and including a bore formed therein and communicative with said chamber of said casing for allowing the water from said compartment of said housing to selectively flow out through said bore of said barrel and to flow out into said chamber of said casing, and
a gasket engaged into said stepped orifice of said membrane, and including a bore formed therein, and including an outer peripheral flange engaged into said relatively wider orifice portion of said membrane and engaged with said inner peripheral shoulder of said membrane for anchoring said gasket to said membrane, and including at least one slot formed in said outer peripheral flange and extended radially for allowing the water to flow through said at least one slot of said outer peripheral flange of said gasket and to flow into said compartment of said housing.

2. The water flushing device as claimed in claim 1, wherein said outer peripheral flange of said gasket includes a thickness smaller than a depth of said wider orifice portion of said membrane for allowing said outer peripheral flange of said gasket to be engaged within said wider orifice portion of said membrane.

3. The water flushing device as claimed in claim 1, wherein said membrane includes a protruded flange extended outwardly from said membrane and disposed and arranged around said narrowed orifice portion of said membrane.

4. The water flushing device as claimed in claim 1, wherein said gasket includes a lower peripheral flange engaged with said protruded flange of said membrane.

5. The water flushing device as claimed in claim 1, wherein said bore of said gasket is a stepped bore.

6. The water flushing device as claimed in claim 1, wherein said membrane includes an inner peripheral rim and an outer peripheral rim for forming and defining a middle peripheral portion between said inner peripheral rim and said outer peripheral rim.

7. The water flushing device as claimed in claim 6, wherein said membrane includes a plurality of bulges formed and located in said middle peripheral portion for reinforcing said membrane.

8. The water flushing device as claimed in claim 6, wherein said membrane includes a blade engaged in said inner peripheral rim for reinforcing said membrane.

9. The water flushing device as claimed in claim 6, wherein a cover is engaged onto said housing and engaged with said outer peripheral rim of said membrane for forming a sealed compartment between said membrane and said cover.

10. The water flushing device as claimed in claim 6, wherein a cap is engaged with said barrel and engaged with said inner peripheral rim of said membrane for securing said barrel to said membrane.

11. The water flushing device as claimed in claim 6, wherein said membrane includes at least one depression formed in an outer peripheral portion of said inner peripheral rim.

12. The water flushing device as claimed in claim 6, wherein said membrane includes a plurality of cavities formed and located in said middle peripheral portion of said membrane.

13. The water flushing device as claimed in claim 12, wherein said membrane includes a plurality of bars extended outwardly from said membrane and disposed and arranged around said cavities of said membrane for reinforcing said membrane.

14. The water flushing device as claimed in claim 1, wherein said barrel includes a bore communicative with said opening of said membrane, and said valve device includes a stem extended into said bore of said barrel.

15. The water flushing device as claimed in claim 14, wherein an actuating device is attached and secured to said housing and includes an actuating rod extended into said housing and engageable with said stem of said valve device for selectively tilting said stem and said valve device relative to said barrel, and includes an actuating lever extended out of said housing for operating said actuating rod.
